(19) United States
(12) Patent Application Publication
(10) Pub. No.: US 2016/0047707 A1
(43) Pub. Date: Feb. 18, 2016

(54) RESONANCE GENERATING APPARATUS WITH REDUCED SIDE LOADS FOR A BLADE'S FATIGUE TESTING

(71) Applicant: KOREA INSTITUTE OF MACHINERY AND MATERIALS, Daejeon (KR)

(72) Inventors: Hak Gu Lee, Incheon (KR); Ji Sang Park, Gyeongsangnam-do (KR); Do Young Kim, Jeollabuk-do (KR); Soon Ho Yoon, Gyeongsangnam-do (KR)

(73) Assignee: KOREA INSTITUTE OF MACHINERY AND MATERIALS, Daejeon (KR)

(21) Appl. No.: 14/925,165

(22) Filed: Oct. 28, 2015

Related U.S. Application Data
(63) Continuation of application No. PCT/KR2014/003234, filed on Apr. 15, 2014.

(30) Foreign Application Priority Data
May 16, 2013 (KR) 10-2013-0055607

(51) Int. Cl. G01M 5/00

(52) U.S. Cl. CPC G01M 5/0016

(57) ABSTRACT

A resonance generating apparatus for testing blade fatigue with reduced side load includes a mounting portion comprising a saddle including a groove corresponding to an external surface of a blade, and an assembling portion positioned on an external side of the saddle and joined by tightening members so that the saddle presses against the blade, a resonance generator including an actuator to generate a linear movement, a coupler(s) to maintain phase of a blade motion the same as an actuator rod, and a linear guide to guide a direction of linear reciprocating motion of an actuator body, and weights mounted on opposite faces of the actuator body to move in association therewith, and varied in a lengthwise direction of the blade so a center of gravity of moving masses of the actuator body in linear reciprocation and the additional weights is positioned on an axis of the actuator rod.

### TECHNICAL FIELD

The present invention relates to a resonance generating apparatus with reduced side loads for a blade's fatigue testing, and more particularly, to a resonance generating apparatus with reduced side loads for a blade's fatigue testing, which includes a light-weighted mounting portion provided in contact with an external surface of the blade, a plurality of actuators provided on an external side of the mounting portion, and a resonance generator configured to reciprocate in parallel relationship with a moving direction of the actuator body and simultaneously to prevent the resonance generator's motions in lengthwise and widthwise directions of the blade, whereby generation of side loads is minimized.

The present invention relates to a resonance generating apparatus with reduced side loads for a blade's fatigue testing, in which weight of the resonance generator takes up most of the total weight of the resonance generating apparatus so as to reduce weight of the resonance generating apparatus, and additional weights are attachable and detachable to and from a side of the resonance generator to improve user convenience.

### BACKGROUND

Wind turbine blades for the purpose of wind power generation are somewhat distinguished from blades for aviation which are configured to generate lift, thrust and control forces, as the wind turbine blades for wind power generation are configured to obtain rotary forces necessary to rotate an electric generator to thus produce electric power.

The rotation of the blades causes aerodynamic force distribution around the blades, and this phenomenon acts as bending loads and torsional loads on the blades. Accordingly, an apparatus is necessary, which can monitor aerodynamic loads for safe operation of the blades, and also measure aerodynamic force distribution in spanwise directions of the blades. Accordingly, the resonance generating apparatus for simulating aerodynamic force distribution has been developed in a variety of forms.

For example, Korean Patent Publication No. 10-2011-0078999 discloses an apparatus for measuring aerodynamic load (see FIG. 1), which includes a calibration device 40 as one of the components thereof. The calibration device 40 includes a plurality of rings 41, 42, 43, 44 to receive weights thereon, and spaces 45 to receive blades therein. However, since the calibration device 40 measures the aerodynamic load in a manner in which end of wire is connected to the rings 41, 42, 43, 44 and torsion is repeatedly exerted, such way of measuring has limited accuracy of fatigue measurement.

For another example, WO2009/135136 discloses a system 1 for resonant testing on blade 2 using linearly-reciprocating actuators 10, 20, 30 (see FIG. 2).

However, the conventional technologies including the above require a considerable amount of cost to construct a system 1 for the purpose of resonant blade testing, and also suffer a shortcoming of decreasing resonance frequency because the system's boundary condition is far from the clamped condition of the cantilever beam.

FIG. 3 is a schematic view of fatigue testing equipment developed by the National Renewable Energy Laboratory (USA). The fatigue testing equipment includes a frame 7 formed on an upper surface of the blade, and an actuator 5 formed in the frame 7 for linear reciprocation in a perpendicular direction. Additional weights 6 can be hung at a lower end of the actuator 5 to oscillate the blade in perpendicular direction.

However, the conventional constitution like the one explained above has a shortcoming of deteriorating durability of the hydraulic actuator, because loads in a blade's spanwise direction and chordwise direction on the additional weights 6 at the lower end of the actuator 5 can make the actuator's sealing parts worn out during oscillation of the blade.

FIG. 4 is a schematic view of another fatigue testing equipment developed by NREL, USA. The fatigue testing equipment includes actuators 8 on left and right sides, respectively, and an actuator 8 configured to linearly reciprocate additional weight 9 in perpendicular direction to thus generate a blade's vibration amplitude.

However, the above construction has a shortcoming of oil leakage, because side load is generated on the actuators 8 due to misalignment between operating line of the actuators 8 and the center of gravity of the additional weight 9, which inevitably wears out the seal on the actuators 8.

FIG. 5 is a schematic view of UREX system developed by MTS. The UREX system includes actuators A mounted on both sides of a blade seat P, with additional weight (W) mounted on the actuators A in the chordwise direction (i.e., widthwise direction) of the blade B.

To place the actuators A in the chordwise direction of the blade B, it is necessary to align the center of gravity of an excitation apparatus in thickness direction (i.e., in perpendicular direction) of the blade to the pitch axis. By doing so, the side loads generated by the motion of the blade during resonance testing can be reduced.

However, notwithstanding the advantages mentioned above, the UREX system is in such a construction that is not suitable for the purpose of exciting large-scale blade. That is, because additional weight (W) is mounted in only one direction of the actuators A, when the additional weight increases, the center of gravity of mass of moving object is distanced away from the axis of the actuator rod, thus causing side loads to be generated on the actuators A. As a result, its durability decreases, since wear of the actuator seal is accelerated.

### SUMMARY

The present invention has been made to solve the problems occurring in the prior art explained above, and accordingly, it is an object of the present invention to provide a resonance generating apparatus with reduced side loads for a blade's fatigue testing, including a mounting portion with reduced weight, attached to contact with an external surface of the blade, a plurality of actuators provided on an external side of the mounting portion, and a resonance generator configured to reciprocate in parallel relationship with a moving direction of the actuator body and simultaneously to prevent the resonance generator's motions in lengthwise and widthwise directions of the blade, whereby generation of side loads is minimized.

It is another object of the present invention to provide a resonance generating apparatus with reduced side loads for a blade's fatigue testing, in which weight of the resonance generator takes up most of the total weight of the resonance generating apparatus so as to reduce weight of the resonance generating apparatus, and additional weights are attachable and detachable to and from a side of the resonance generator to improve user convenience.

To achieve the above objects, the present invention provides a resonance generating apparatus with reduced side loads for a blade's fatigue testing, which includes a mounting portion including a saddle including a groove corresponding in form to an external surface of a blade, and an assembling portion positioned on an external side of the saddle and joined by tightening members so that the saddle presses against the blade, a resonance generator including an actuator configured to generate a linear movement, a coupler or couplers configured to maintain the phase of a blade motion the same as that of the actuator rod, and a linear guide configured to guide a direction of linear reciprocating motion of the actuator body, and additional weights mounted on two opposite faces of the actuator body to move in association therewith, and added or reduced in a lengthwise direction of the blade so that a center of gravity of moving masses in linear reciprocation including the actuator body and the additional weights is positioned on the axis of the actuator rod.

According to the present invention, a light-weighted mounting portion is provided in contact with an external surface of the blade, a plurality of actuators are provided on an external side of the mounting portion, and a resonance generator is configured to reciprocate in parallel relationship to a moving direction of the actuator body and simultaneously to prevent the resonance generator's motions in lengthwise and widthwise directions of the blade.

According to the present invention, instead of a conventional way in which actuator rod with additional weights is moved, additional weights are mounted on the actuator body and the actuator body with the additional weights thereon is moved, so that during resonance testing, moving distance of the additional weights to the blade is minimized and accordingly, generation of side loads is minimized. Further, mass of the moving resonance generator takes up most of the total weight of the resonance generating apparatus.

Accordingly, the resonance generating apparatus can be light-weighted, and have improved strength and durability.

Further, since additional weights are attached to and detachable from one side of the resonance generator, user convenience increases.

### BRIEF DESCRIPTION OF THE DRAWINGS

FIG. 1 is a perspective view of a calibrating device as disclosed in KR Patent Publication No. 10-2011-0078999;

FIG. 2 is a schematic view of a resonance test system as disclosed in WO2009/135136;

FIG. 3 is a schematic view of fatigue testing equipment developed by the National Renewable Energy Laboratory (USA);

FIG. 4 is a schematic view of another fatigue testing equipment developed by NREL (USA);

FIG. 5 is a schematic view of the UREX system developed by MTS;

FIG. 6 is a perspective view of a resonance generating apparatus for a blade's fatigue testing purpose in installed state, according to the present invention;

FIG. 7 is a perspective view of an outer constitution of a resonance generating apparatus for a blade's fatigue testing, according to the present invention;

FIG. 8 is a perspective view illustrating a weight frame as one of the components of a resonance generating apparatus for a blade's fatigue testing being moved upward, according to the present invention;

FIG. 9 is a perspective view of a mounting portion as one of the components of the resonance generating apparatus for a blade's fatigue testing, according to the present invention;

FIG. 10 is an exploded perspective view of a resonance generator as a main constitution of a resonance generating apparatus for a blade's fatigue testing, according to an embodiment of the present invention;

FIG. 11 is an exploded perspective view of a constitution of a resonance generating apparatus for a blade's fatigue testing, according to another embodiment of the present invention;

FIG. 12 is a cross section view of a constitution of a linear guide groove of a resonance generating apparatus for a blade's fatigue testing, according to an embodiment of the present invention;

FIG. 13 is a cross section view of a constitution of a linear guide groove of a resonance generating apparatus for a blade's fatigue testing, according to another embodiment of the present invention;

FIG. 14 is a perspective view of another constitution of a mounting portion as one of components of a resonance generating apparatus for a blade's fatigue testing, according to an embodiment of the present invention; and

FIG. 15 is a perspective view of a resonance generating apparatus for a blade's fatigue testing in installed state, according to another embodiment of the present invention.

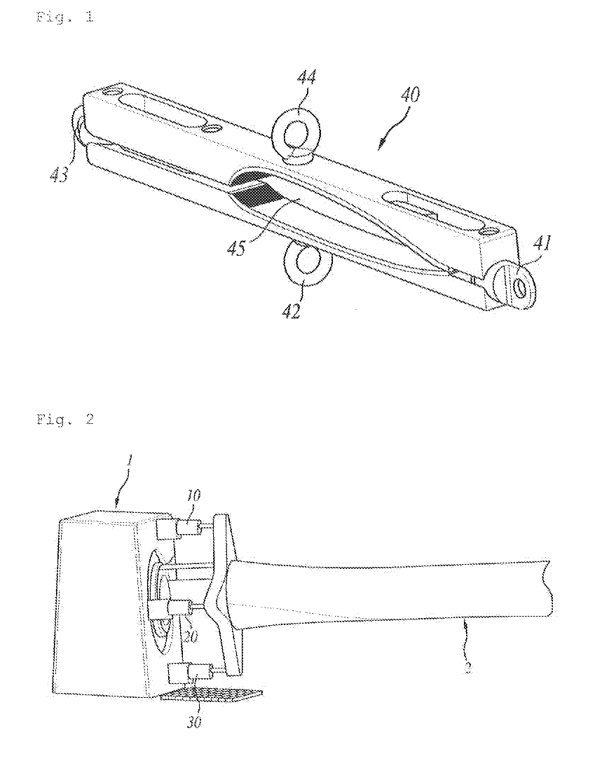

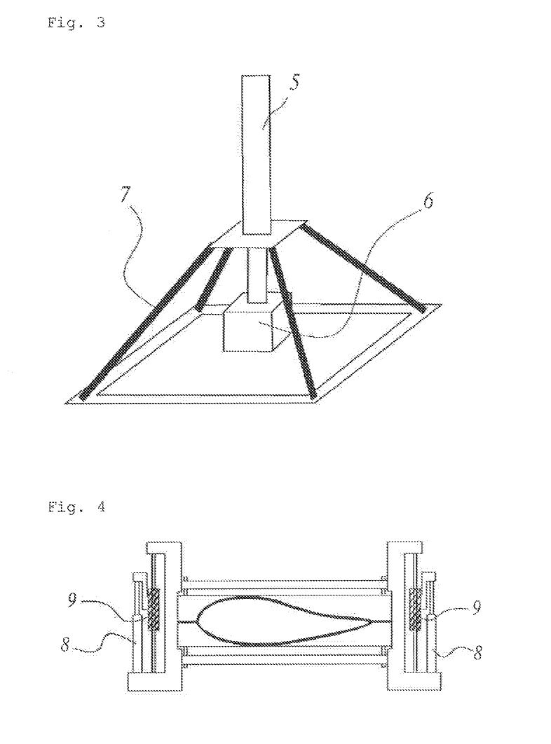

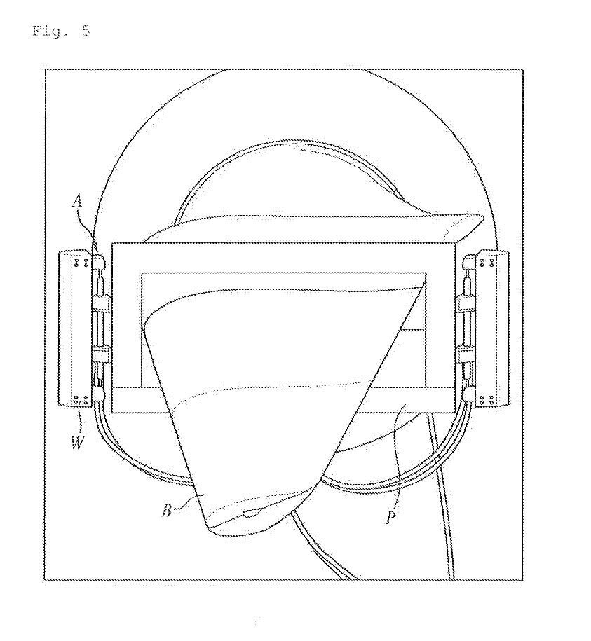

### DETAILED DESCRIPTION

A resonance generating apparatus for a blade's fatigue testing according to the present invention includes a mounting portion including a saddle including a groove corresponding in form to an external surface of a blade, and an assembling portion positioned on an external side of the saddle and joined by tightening members so that the saddle presses against the blade, a resonance generator including an actuator configured to generate a linear movement, a coupler or couplers configured to maintain the phase of a blade motion the same as that of the actuator rod, and a linear guide configured to guide a direction of linear reciprocating motion of the actuator body, and additional weights mounted on two opposite faces of the actuator body to move in association therewith, and added or reduced in a lengthwise direction of the blade so that a center of gravity of moving masses in linear reciprocation including the actuator body and the additional weights is positioned on the axis of the actuator rod.

The linear guide may include a moving portion configured to move linearly in association with the actuator body, and a fixing portion configured to guide a direction of movement of the moving portion.

A center of gravity of the resonance generator may be positioned at a pitch axis, when displacement of the actuator body is “0”.

The resonance generator may include a weight frame configured to support from an outer side of the mounting portion so that the actuator body and the additional weights are moved in association with each other.

The linear guide may guide the movement of the body of the actuator to a direction parallel to a direction in which the actuator is extended or contracted. On the other hand, the linear guide may be configured to prevent the actuator body from moving to a direction across a direction in which the actuator is extended or contracted.

A blocker may preferably be provided between the mounting portion and the resonance generator to limit movement of the mounting portion with respect to the resonance generator when the resonance generator generates resonance.

A position at which the saddle is fixed may be variable in a lengthwise direction of the assembling portion.

Hereinafter, the present invention will be explained in more detail with reference to the following Examples. However, the following Examples are only provided only for illustrative purpose, and therefore, do not limit the scope of the present invention.

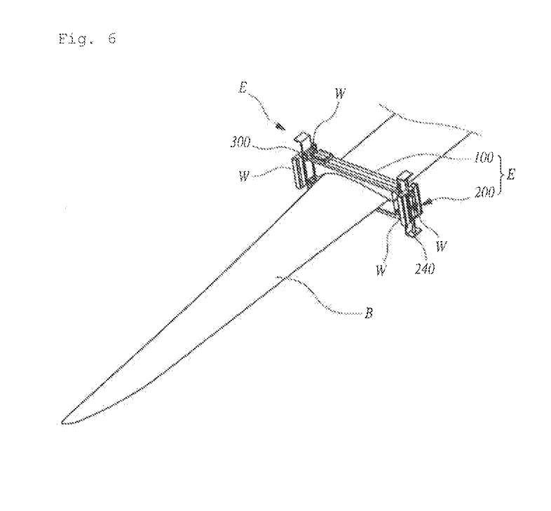

The resonance generating apparatus for a blade's fatigue testing (shortly, ‘resonance generating apparatus’ E) according to an embodiment of the present invention in use will be explained below, with reference to FIG. 6.

FIG. 6 is a perspective view of the resonance generating apparatus E for a blade's fatigue testing in installed state, according to the present invention. As illustrated in FIG. 6, the resonance generating apparatus E is connected to an external surface of the subject of fatigue testing (i.e., a blade B) to generate resonance, in which the blade B is tightened and fixed in a state of being passed through interior of the resonance generating apparatus E.

That is, the resonance generating apparatus E includes a mounting portion 100 integrally connected in contact with the external surface of the blade B, and a plurality of resonance generators 200 connected to an external side of the mounting portion 100 to generate resonance on the blade B by linearly reciprocating with respect to the mounting portion 100 in association with lengthwise extension and contraction of the actuator 240.

The resonance generating apparatus E includes additional weights W on left and right sides, and the additional weights are configured to be added or reduced depending on the size, shape and center of gravity of the blade B.

To be more specific, the additional weights W are provided on the respective resonance generators 200. The additional weights W are positioned on an external side in a widthwise direction of the blade B, and fixed in position to face each other in the widthwise direction of the resonance generating apparatus E (i.e., lengthwise direction of the blade B).

The resonance generators 200 of the resonance generating apparatus E, which are configured to generate resonance by moving upward and downward with respect to the blade B, are positioned on the external side, and take up most weight of the total weight of the resonance generating apparatus E. That is, the resonance generators 200 are positioned on the external side of the mounting portion 100, and linearly reciprocate in upward and downward directions with the additional weights W hung thereon.

Accordingly, among a plurality of constituent components of the resonance generating apparatus E, the resonance generators 200 are the main constituent components, taking up most weight of the resonance generating apparatus E.

Accordingly, the total weight of the resonance generating apparatus E is reduced.

A connector 300 is formed between each resonance generator 200 and the mounting portion 100. The connector 300 is connected to upper and lower ends of the mounting portion 100, and connected at external side thereof to each resonance generator 200, thus connecting each resonance generator 200 and the mounting portion 100.

As explained above, the connector 300 may be employed to connect the resonance generators 200 and the mounting portion 100, but not limited thereto. For example, the resonance generators 200 may be directly connected with the mounting portion 100, in which case the connector 300 may be omitted.

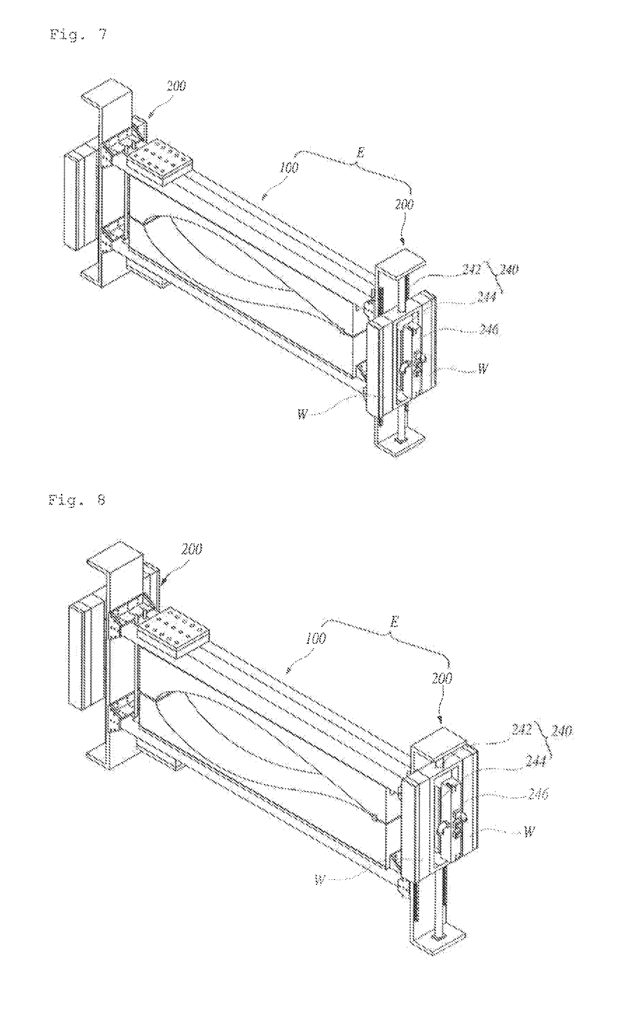

The constitution of the resonance generating apparatus E will be explained below with reference to FIGS. 7 and 8.

FIG. 7 is a perspective view illustrating outer appearance of the resonance generating apparatus for a blade's fatigue testing, according to an embodiment of the present invention, and FIG. 8 is a perspective view illustrating a weight frame, one of the components of the resonance generating apparatus for a blade's fatigue testing, moving upward, according to an embodiment of the present invention.

Referring to FIGS. 7 and 8, the resonance generating apparatus E includes a mounting portion 100 and a resonance generator 200. The resonance generator 200 is configured so that its center of gravity is at a pitch axis when displacement of an actuator body 244 is “0”, while the resonance generator 200 generates resonance when the displacement of the actuator body 244 changes (see FIG. 8).

Referring to FIG. 7, the resonance generator 200 according to a preferred embodiment of the present invention generates resonance with the operation of the actuator 240. That is, with an actuator rod 242 being maintained at a predetermined position with respect to the blade B, the resonance is generated as the position of the actuator body 244 is changed.

To be more specific, while the length of the actuator rod 242 varies according to a direction in which the fluid is fed through the flowrate regulator 246, the actuator rod 242 is restricted to maintain a predetermined phase with respect to the blade B. As a result, the actuator body 244 is guided along the actuator rod 242 to linearly reciprocate in upward and downward directions (leftward and rightward directions in the example of FIG. 7).

The actuator body 244, which is at a center of the actuator rod 242 (see FIG. 7), is linearly reciprocated to corresponding direction (see FIG. 8), as the fluid introduced through the flowrate regulator 246 is fed into the actuator 240.

Meanwhile, according to the present invention, the actuator body 244 is configured to be movable, to reduce side loads. That is, in conventional examples (see FIG. 5), additional weights W are mounted on the actuator A. As the actuator rod moves, the actuator body is positioned at the center, according to which the actuator rod is reciprocated, with an end of the actuator rod either descending or ascending further. Accordingly, since the moving masses are moved farther away from the blade B, more side loads are generated.

To address the problem mentioned above, according to the present invention, the actuator 240 is so configured that the actuator body 244 thereof is movable. Additionally, both ends of the actuator rod 242 are fixed in position, allowing the actuator body 244 with additional weights W mounted thereon to linearly reciprocate only in an area defined between both ends of the actuator rod 242. As a result, since a distance that the moving masses travel farther away from the blade B is minimized, side loads are minimized.

The detailed constitution of the resonance generating apparatus E will be explained below.

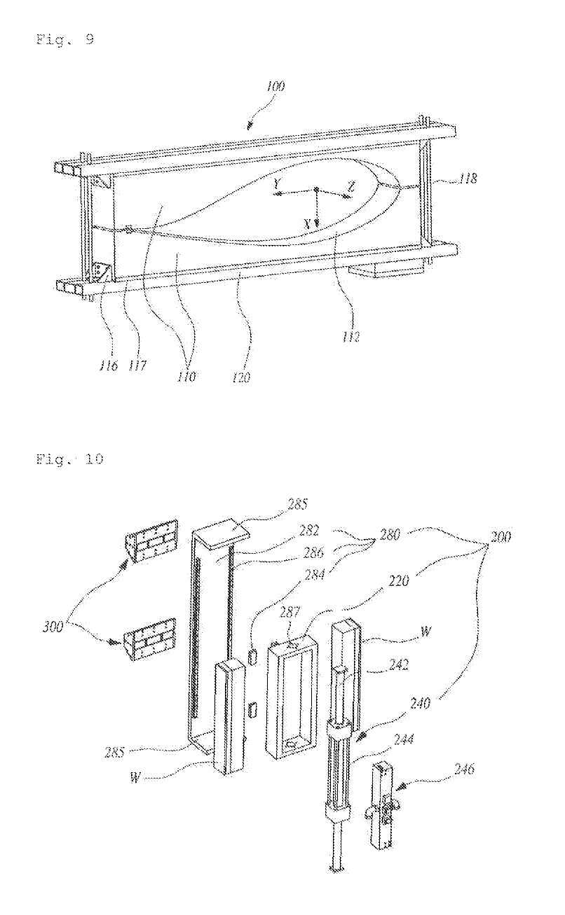

Hereinbelow, the detailed constitution of the mounting portion 100 will be explained with reference to FIG. 9. FIG. 9 is a perspective view of the mounting portion 100 as one of the components of the resonance generating apparatus E for a blade's fatigue testing, according to the present invention.

The mounting portion 100 is configured to support the resonance generator 200 to transmit vibration forces to the blade B. The mounting portion 100 includes a saddle 110 composed of a plurality of parts and connected to surround external side of the blade B, and an assembling portion 120 configured to integrate the blade B and the saddle 110 by providing the saddle 110 with compressive forces.

The mounting portion 100 includes a saddle 110 including two or more parts and a groove 112 corresponding in form with an outer shape of the blade B, and an assembling portion 120 configured to maintain the saddle 110 in seated relationship with the blade B by generating inward restricting force from outside to the saddle 110.

The groove 112 of the saddle 110 is recessed to a shape that corresponds to a cross section of the blade B, so that, when the parts above and below are moved close to each other, the groove 112 is brought into surface contact with an external surface of the blade B, thus transmitting the force from the resonance generating apparatus E to the blade B.

The assembling portion 120 is provided to an upper side and a lower side of the saddle 110. The assembling portion 120 provides a plurality of component parts of the saddle 110 with compressive forces.

Additionally, the assembling portion 120 restricts the saddle 110 from oscillating in forward and backward directions or leftward and rightward directions. To this end, the assembling portion 120 may include a left and right restraint 116 to limit leftward and rightward movement (when viewed in FIG. 9) of the saddle 110, and a front and back restraint 117 to limit forward and backward movement of the saddle 110. Additionally, the assembling portion 120 includes tightening members 118 on a left side and a right side to exert pressure on the saddle 110 by tightening the assembling portion 120. The mounting portion 110 is so configured that a center of gravity thereof is positioned at a pitch axis. That is, because the center of gravity of the mounting portion 100 including the saddle 110, the assembling portion 120 and the tightening members 118, is positioned at the pitch axis, side loads such as torsion can be prevented when the blade B is moved upward and downward due to resonance.

Hereinbelow, the detailed constitution of the resonance generator 200 will be explained with reference to FIG. 10.

FIG. 10 is a detailed exploded perspective of the resonance generator as a main component of the resonance generating apparatus for a blade's fatigue testing, according to the present invention.

Referring to FIG. 10, the resonance generator 200 includes an actuator 240, and is so configured that the vibration forces generated by the changing length of the actuator 240 is transmitted via the assembling portion 120 via the saddle 110 and the blade B in turn.

Accordingly, the resonance generator 200 and the mounting portion 100 may be connected to each other in a variety of manners, provided that the vibration forces generated in accordance with extension and contraction of the length of the actuator 240 can be transmitted to the blade B.

Referring first to the constitution of the embodiment illustrated in FIG. 10, the resonance generator 200 includes a weight frame 220 with additional weights W provided thereon, configured to linearly reciprocate on an external side of the mounting portion 100 in association with the actuator 240, an actuator 240 connected to at least one side of the weight frame 220 to restraint linear reciprocal motion of the weight frame 220 and to provide the blade B with vibration forces, and a linear guide 280 configured to guide the movement of the weight frame 220 with respect to the mounting portion 100 when the length of the actuator 240 is extended or contracted (i.e., when the actuator body 244 is moved).

The resonance generator 200 is so configured that the weight frame 220 is moved in association with the displacement of the actuator body 244. The actuator rod 242 is moved at the same phase as that of the mounting portion 100.

The shape of the weight frame 220 may be hollow, closed-shell, or closed-loop. The actuator 240 is received in the weight frame 220.

The linear guide 280 is configured to guide the weight frame 220 moving in association with the actuator 240, so that the weight frame 220 is moved in a linear reciprocating manner in upward and downward directions. In one embodiment, the linear guide 280 is connected to the connector 300.

That is, the linear guide 280 guides the movement of the weight frame 220 in a direction parallel to a direction of movement of the actuator body 244, while preventing the weight frame 220 from moving in a direction across the direction of linear reciprocation of the actuator body 244.

To this end, the linear guide 280 includes a coupler or couplers 282 connected with respect to the mounting portion 100 to restrict movement, a moving portion 284 positioned on one side of the coupler 282 to linearly reciprocate, and a fixing portion 286 fixed to one side of the coupler 282 to restrict a direction of movement of the moving portion 284.

The coupler 282 is connected, in surface contact, with the connector 300 by tightening elements, and includes flanges 285 extending from an upper end and a lower end. The actuator 240 has a length that corresponds to a distance between the flanges 285 on upper and lower sides.

The upper and lower ends of the actuator rod 242 are fixed on opposing surfaces of the flanges 285, and the upper and lower centers of the weight frame 220 include holes 287 to permit the actuator rod 242 to pass therethrough.

The holes 287 are provided to allow the weight frame 220 to linearly reciprocate in upward and downward directions in accordance with the guidance of the actuator rod 242.

The moving portion 284 is inserted in the fixing portion 286 in a manner of linearly reciprocating in upward and downward directions, and the moving portion 284, which is fixed to a rear surface of the weight frame 220, is movably connected to the fixing portion 286 to be linearly moved in upward and downward directions. Accordingly, as the actuator 240 moves and the actuator body 244 thereof moves, the weight frame 220 is moved relative to the actuator rod 242 in association with the actuator body 244, during which the moving portion 284 is linearly reciprocated through the fixing portion 286 to thus guide linear reciprocating movement of the weight frame 20.

The additional weights W are connected to both sides of the weight frame 220, and can be added or reduced, depending on need. The flowrate regulator is fixedly connected to the actuator body 244.

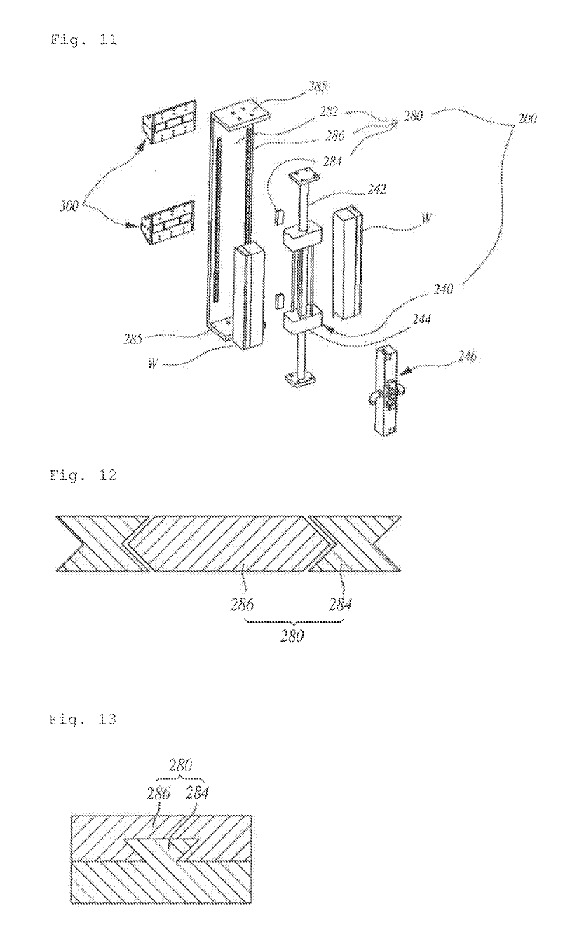

FIG. 11 illustrates the resonance generator 200 in another modified embodiment. Accordingly, FIG. 11 is an exploded perspective view illustrating constitution of the resonance generating apparatus for a blade's fatigue testing, according to another embodiment of the present invention. FIG. 11 particularly illustrates when sufficient rigidity of the actuator 240 is ensured, in which case the joining structure of the additional weights W and the linear guide 280 is modified.

That is, the additional weights W may be mounted on the left and right sides of the actuator 240 (i.e., in lengthwise direction of the blade B) to face each other, and the moving portion 284 may be attached on the actuator body 244, while the fixing portion 286 is fixed on the coupler 282.

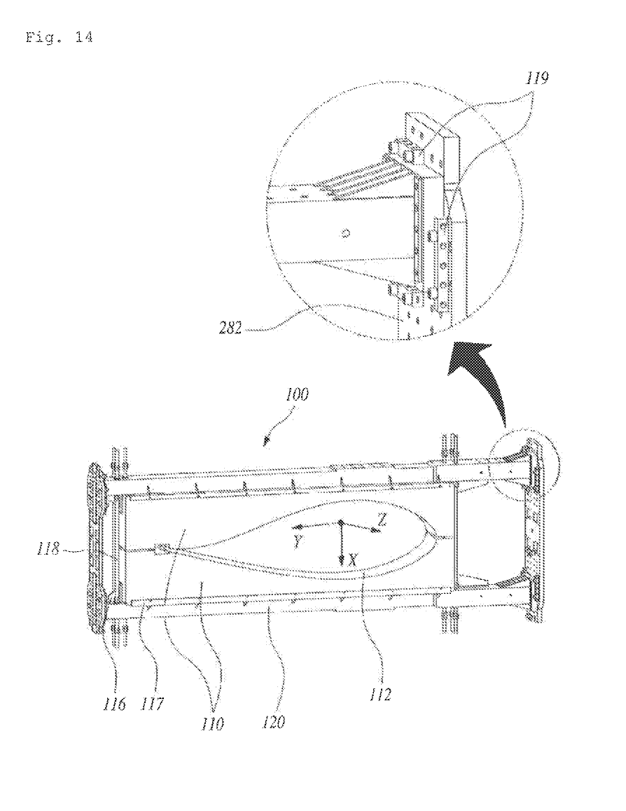

Meanwhile, FIGS. 12 and 13 illustrate the fixing portion 286 and the moving portion 284 according to various embodiments. FIG. 12 is a cross section of a linear guide of the resonance generating apparatus for a blade's fatigue testing, according to one embodiment of the present invention, and FIG. 13 is a cross section of a linear guide of a resonance generating apparatus for a blade's fatigue testing according to another embodiment of the present invention.

Referring to FIGS. 12 and 13, the fixing portion 286 and the moving portion 284 are in complementary shapes to each other, and may be formed in various shapes and structures, provided that the fixing portion 286 and the moving portion 284 allow movement of the weight frame 220 in upward and downward directions, while preventing movement in the rest directions.

The connector 300 may be omitted, when sufficient rigidity of the coupler 282 is ensured, in which case the coupler 282 may be directly coupled to the assembling portion 120.

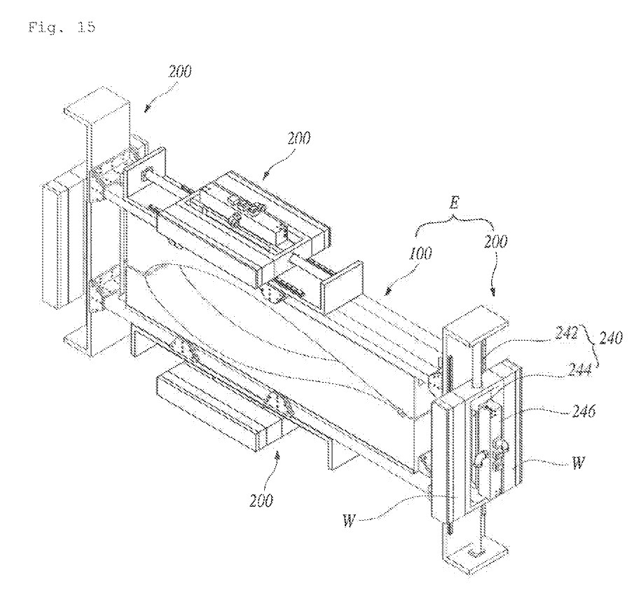

The structure of the mounting portion 100 according to another embodiment will be explained in detail below with reference to FIG. 14.

FIG. 14 is a perspective view illustrating a constitution of the mounting portion of a resonance generating apparatus for a blade's fatigue testing, according to another embodiment of the present invention.

Referring to FIG. 14, the mounting portion 100 may be fixed in a manner in which the saddle 110 is deviated to one side. That is, because the pitch axis of the blade B is at approximately ¼ point of the blade chord, the weight ratio of the resonance generators 200 mounted on the left and right sides of the mounting portion 100 is determined in accordance with the distance ratio from the pitch axis. Accordingly, the additional weights W and the size of the actuator 240 vary.

Thus, aligning the center of gravity of the left and right resonance generators 200 to the pitch axis, which causes the inevitable excessive weight difference between the two resonance generators, makes the design of a resonance generating apparatus difficult. To alleviate the shortcoming mentioned above, the assembling portion 120 may be lengthened at one side (see FIG. 14) to thus increase a distance between the saddle 110 and the resonance generator 200.

By doing so, the distance gap between the pitch axis to the resonance generators 200 on left and right sides can be alleviated.

Naturally, it is thus possible to install the saddle 110 in a manner of deviating to one side with respect to the assembling portion 120.

The blocker 119 is provided on an end of the assembling portion 120 to increase attaching forces to the counterpart, i.e., to the resonance generator 200. The blocker 119 may be connected to a predetermined area (i.e., upper, lower, left or right side area) between the end of the assembling portion 120 and the resonance generator 200 joined therewith, to limit even the minute movement of the resonance generator 200 (i.e., movement due to tolerance of the fastening member such as bolt).

Although certain embodiments have been explained so far, the present invention is not limited to any specific embodiment, but can be modified by a person with ordinary skill in the art in the pertinent technical field.

For example, while it was explained herein and illustrated mainly in FIG. 6 that the resonance generators 200 may be formed front and rear sides of the blade B in a widthwise direction to generate resonance in a thickness direction of the blade B, another embodiment is also possible. For example, as illustrated in FIG. 15, the present invention may be so configured that the resonance is generated also in the chordwise or edgewise direction of the blade B, concurrently.

In the specific embodiment mentioned above, the center of gravity of the resonance generators 200 on the upper and lower sides of the mounting portion 100 may preferably be positioned on the pitch axis when the displacement of the actuator body is “0”.

Further, instead of providing the resonance generators 200 on left and right sides of the mounting portion 100, these may be exclusively formed on upper and lower surfaces.

### DESCRIPTION OF REFERENCE NUMERALS

100: mounting portion
110: saddle
112: groove
116: left and right restraints
117: front and back restraints
118: tightening member
119: blocker
120: assembling portion
200: resonance generator
220: weight frame
240: actuator
242: actuator rod
244: actuator body
246: flowrate regulator
280: linear guide
282: coupler
284: moving portion
285: flange
286: fixing portion
287: hole
300: connector
B: blade
E: resonance generating apparatus
W: additional weight

What is claimed:

1. A resonance generating apparatus with reduced side loads for a blade's fatigue testing, comprising:
a mounting portion comprising a saddle, the saddle comprising a groove corresponding in form to an external surface of a blade, and an assembling portion positioned on an external side of the saddle and joined by tightening members so that the saddle presses against the blade;
a resonance generator comprising an actuator configured to generate a linear movement, at least one coupler configured to maintain phase of a blade motion as the same as that of an actuator rod, and a linear guide configured to guide a direction of linear reciprocating motion of an actuator body; and
additional weights mounted on two opposite faces of the actuator body to move in association therewith, and one of added or reduced in a lengthwise direction of the blade so that a center of gravity of moving masses in linear reciprocation including the actuator body and the additional weights is positioned on an axis of the actuator rod.

2. The resonance generating apparatus of claim 1, wherein the linear guide comprises:
a moving portion configured to move linearly in association with the actuator body; and
a fixing portion configured to guide a direction of movement of the moving portion.

3. The resonance generating apparatus of claim 1, wherein a center of gravity of the resonance generator is positioned at a pitch axis when displacement of the actuator body is “0”.

4. The resonance generating apparatus of claim 1, wherein a center of gravity of the mounting portion is at a pitch axis.

5. The resonance generating apparatus of claim 1, wherein the resonance generator comprises a weight frame configured to support, from an outer side of the mounting portion, so that the actuator body and the additional weights are moved in association with each other.

6. The resonance generating apparatus of claim 2, wherein the linear guide guides the movement of the actuator body to a direction parallel to a direction in which the actuator is extended or contracted.

7. The resonance generating apparatus of claim 2, wherein the linear guide prevents the actuator body from moving to a direction across a direction in which the actuator is extended or contracted.

8. The resonance generating apparatus of claim 1, further comprising at least one blocker provided between the mounting portion and the resonance generator to limit movement of the mounting portion with respect to the resonance generator when the resonance generator generates resonance.

9. The resonance generating apparatus of claim 1, wherein a position at which the saddle is fixed is variable in a lengthwise direction of the coupler.
